(19) United States
(12) Patent Application Publication
(10) Pub. No.: US 2002/0176659 A1
(43) Pub. Date: Nov. 28, 2002

(54) Dynamically tunable resonator for use in a chromatic dispersion compensator

(75) Inventors: Gang Lei, San Jose, CA (US); Yuan Shi, Fremont, CA (US); Paul Colbourne, Nepean (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/042,798

(22) Filed: Jan. 9, 2002

Related U.S. Application Data
(60) Provisional application No. 60/291,975, filed on May 21, 2001.

(51) Int. Cl. G02B 6/28

(52) U.S. Cl. 385/24

(57) ABSTRACT

A tunable etalon for use in a dispersion compensator according to the present invention includes a Gires-Tournois (GT) etalon with a variably reflective front mirror section and a fixed back mirror section defining a resonance cavity therebetween. The front mirror section includes one or more tunable gaps formed between pairs of partially reflective mirrors and filled with a material with a variable index of refraction, e.g. liquid crystal. Due to the variability of the material's refractive index, the reflectivity of the tunable cavity can be adjusted by inducing an electric field using a controllable voltage source. With such a variable reflectivity, the time (group) delay among frequency components of input light can be adjusted and varied within a range of a few milliseconds or less, such that chromatic dispersion can be tuned dynamically. A pair of such etalons, which have equal and opposite dispersion curves, can achieve a wide flat range of dispersion. A plurality of etalons, connected in series, can achieve a greater range of tunable dispersion. A similar dispersion compensator can be formed using a ring resonator with a variable coupler.

### CROSS-REFERENCE TO RELATED APPLICATION

The present application claims the benefit of U.S. Provisional Application Serial No. 60/291,975, filed May 21, 2001, entitled: “Dynamically Tunable Chromatic Dispersion Compensators” by G. Lei et al, assigned to the assignee of the present application, and the disclosure of which is incorporated herein.

### TECHNICAL FIELD

The present invention relates in general to an optical resonator with a variable input, and in particular to an etalon with a variably reflective front mirror or a ring resonator with a variable coupling for use in compensating dispersion of light signals.

### BACKGROUND INFORMATION

In high bit rate light-wave systems, tunable chromatic dispersion compensators are required to compensate for the various dispersions accumulated along the different paths taken by each of the individual signal channels. Known dispersion compensation techniques include dispersion compensation fibers, chirped Bragg grating, and cascaded Mach-Zehnder filters. Devices for dispersion compensation are known. U.S. Pat. No. 5,283,845 granted to J. W. Ip on Feb. 1, 1994 discloses a multi-port tunable fiber-optic filter. U.S. Pat. No. 6,141,130 granted to J. W. Ip on Oct. 31, 2000 discloses an amplitude-wavelength equalizer for a group of wavelength division multiplexed channels. U.S. Pat. No. 5,557,468 granted to J. W. Ip on Sep. 17, 1996 discloses a chromatic dispersion compensation device.

A recent approach for dispersion compensation utilizes Gires-Tournois Interferometers (GTI), which potentially provide low-loss and polarization insensitivity, while offering high negative dispersion without exhibiting the nonlinear behavior found in fiber-based dispersion compensating devices. Moreover, GTI's can be made to be colorless for compensating multi-channel dispersion in a very compact device. U.S. Pat. No. 6,081,379 granted to R. R. Austin et al. discloses a monolithic multiple GTI device providing negative group delay dispersion. A GTI is basically an asymmetric Fabry-Perot etalon, providing a constant amplitude response over all frequencies and a phase response that varies with frequency. The key to using a GTI for dispersion compensation is that each frequency component of the signal remains trapped in the interferometer for a longer time as the frequency approaches the interferometer's resonant frequency. Therefore, negative or positive delays depend on the position of the signal spectrum with respect to the resonance peak, and the closer the signal frequency component is to the cavity resonance the greater the delay.

A paper by C. K. Madsen, entitled “Tunable Dispersion Compensating MEMS All-Pass Filter”, IEEE Photonics Technology Letters, Vol. 12, No. 6, June 2000, which is incorporated herein by reference, discloses a tunable dispersion compensation technique with a microelectromechanical (MEM) actuated variable reflector and a thermally tuned cavity. U.S. Pat. No. 6,289,151 granted to Kazrinov et al. discloses an all-pass optical filter for reducing the dispersion of optical pulses by applying a desired phase response to optical pulses transmitted through the filter.

### SUMMARY OF THE INVENTION

It is an object of the present invention to provide an improved apparatus, which is applicable to compensate the dispersion accumulated in the different routes in a high-bit-rate light-wave system.

Accordingly, the present invention relates to a tunable etalon apparatus for receiving input light having input frequency channels therein and for providing output light therefrom, the output light having frequency channels corresponding to the input frequency channels with a relative time delay therebetween

The tunable etalon apparatus comprises:

a first variable partial reflector for reflecting and transmitting portions of the input light; and a back reflector for reflecting the transmitted light back to the partial reflector, the back reflector and the first variable partial reflector forming a cavity therebetween.

The first variable partial reflector comprising:

a pair of partially reflective surfaces defining a gap therebetween, the gap comprising a material with a variable index of refraction; and

control means for adjusting the index of refraction of the material in the gap, thereby controlling the time delay of the input frequency channels.

Accordingly, light reflected by the back reflector is partially reflected by and transmitted through the partial reflector, thereby causing interference in the output light.

Another aspect of the present invention relates to a dispersion compensator comprising a cascaded pair of the aforementioned tunable etalons, preferably wherein the pair of tunable etalons have substantially equal and opposite dispersion curves forming an overall dispersion curve that has a flat top bandwidth for each frequency channel.

Another aspect of the present invention relates to a tunable resonator apparatus for receiving input light having input frequency channels therein and for providing output light therefrom, the output light having frequency channels corresponding to the input frequency channels with a relative time delay therebetween. The tunable resonator apparatus comprises:

an input waveguide for launching the input light;

an output waveguide for transmitting the output light;

a ring resonator having an input and an output; and

a first variable coupler for coupling and distributing light from the input waveguide and the ring resonator input to the output waveguide and the ring resonator output.

The first variable coupler includes:

a material with a variable index of refraction; and

control means for adjusting the index of refraction of the material, thereby controlling the time delay of the input frequency channels.

Input light coupled into the ring resonator by the first variable coupler is transmitted back to the first variable coupler, thereby causing interference in the output light.

Another aspect of the present invention relates to a dispersion compensator comprising a cascaded pair of the aforementioned tunable resonators, preferably wherein the pair of tunable resonators have substantially equal and opposite dispersion curves forming an overall dispersion curve that has a flat top bandwidth for each frequency channel.

### BRIEF DESCRIPTION OF THE DRAWINGS

Examples of the present invention will now be described in relating to the accompanied drawings in which:

FIG. 1 illustrates a conventional Gires-Tournois Interferometer;

FIG. 2 illustrates an apparatus according to an embodiment of the present invention including an air-spaced etalon including one partial reflector defining one interference cavity;

FIG. 3 illustrates an apparatus according to an embodiment of the present invention including a multi-cavity etalon having multiple variable partial reflectors defining multiple interference cavities;

FIG. 4 illustrates an apparatus according to another embodiment of the present invention including a cascaded pair of the etalons of FIG. 2;

FIG. 5 illustrates an apparatus according to another embodiment of the present invention including an air-spaced etalon with a single ferrule for feeding input light into and receiving output light from the etalon of FIG. 2;

FIG. 6 illustrates an apparatus according to another embodiment of the present invention including a solid etalon and a single ferrule for feeding input light into and receiving output light therefrom;

FIG. 7 illustrates an apparatus according to another embodiment of the present invention including a cascaded pair of the air-spaced etalons of FIG. 5;

FIGS. 8A-8D show wavelength-group delay and wavelength-chromatic dispersion characteristics in the apparatus including the pair of etalons shown in FIG. 7;

FIG. 9 shows a variable wavelength-chromatic dispersion characteristic from the pair of etalons of FIG. 7;

FIG. 10 shows a variable wavelength-chromatic dispersion characteristic from two pairs of etalons of FIG. 7;

FIG. 11 shows a variable wavelength-chromatic dispersion characteristic three pairs of the cascade etalons of FIG. 7;

FIG. 12 illustrates an apparatus according to another embodiment of the present invention including two pairs of air-spaced etalons, which are connected in series;

FIG. 13 illustrates an apparatus according to another embodiment of the present invention including two pairs of solid etalons, which are connected in series;

FIG. 14 illustrates an apparatus according to an embodiment of the present invention including a multi-cavity air-spaced etalon having multiple tunable partial reflectors defining multiple air-spaced interference cavities;

FIG. 15 illustrates an apparatus according to an embodiment of the present invention including a solid multi-cavity etalon with multiple partial reflectors defining multiple solid interference cavities;

FIG. 16 illustrates an apparatus according to another embodiment of the present invention including a ring resonator device having a variable light coupling section mounted in a waveguide;

FIG. 17 illustrates an apparatus according to another embodiment of the present invention including a plurality of cascaded ring resonator devices, each being shown in FIG. 16; and

FIG. 18 illustrates an apparatus according to another embodiment of the present invention including a multi-ring resonator device having a plurality of ring-resonator sections mounted on a single waveguide.

### DETAILED DESCRIPTION

I. Related Art

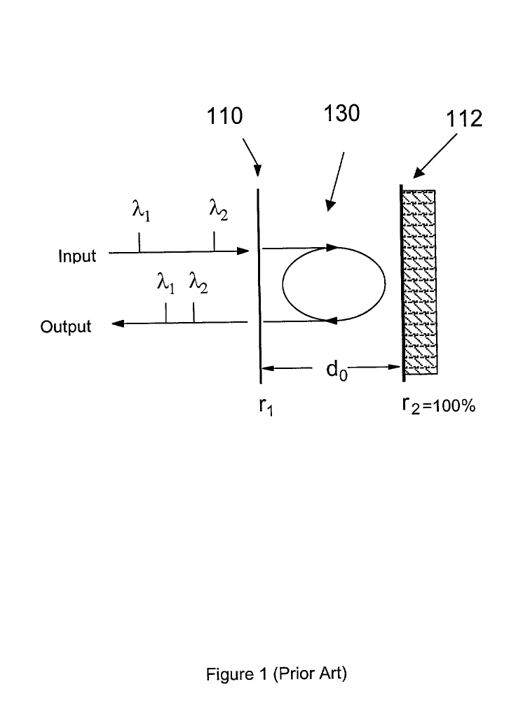

FIG. 1 shows a conventional Gires-Tournois Interferometer (GTI) 100, which is basically an asymmetric Fabry-Perot (FP) etalon. The GTI includes a partially reflective front mirror 110 (reflectivity r₁) and an almost fully reflective back mirror 112 (reflectivity ideally r₂=1) fining a resonance cavity 130 therebetween. Input light including an input frequency component λ, among others, is fed to the interferometer 100. Part of the input light passes through the front mirror 110 and gets reflected by the back mirror 112. An output light signal including an output frequency component corresponding to the input frequency component λ is provided from the front mirror 110. The interferometer 100 provides a constant amplitude response and a varied phase response over the input frequencies. There is regenerative light interference between the front mirror 110 and the back mirror 112. The interference leads to a periodic phase-versus-frequency curve for the complex reflectivity, which varies periodically with the axial mode spacing of the interferometer. The closer a given frequency component is to the resonance frequency, the larger the phase dispersion. The basic idea behind making a GTI a dispersion compensator is that each frequency component of the signal remains trapped in the interferometer structure for a time that is longer as the frequency approaches the interferometer's resonant frequency λ_{R}. Negative or positive delays are obtained depending on the position of the signal spectrum with respect to the resonance peak. Furthermore, the closer the frequency component λ is to the cavity resonant frequency λ_{R}, the greater the time delay.

II. Embodiment

The present invention is focusing on how to make such a device tunable (dynamically) within a time frame of a few ms or less.

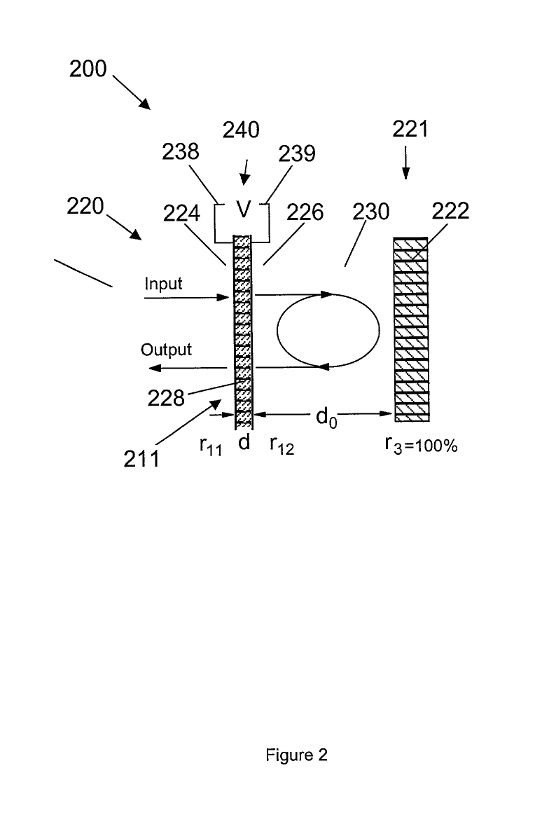

FIG. 2 shows an apparatus according to another embodiment of the present invention including one air-spaced etalon. The etalon includes a front partial reflecting section 220 and a back light reflection section 221. The front partial reflecting section 220 has one variable partial reflector 211, i.e. one tunable gap 228, and one interference cavity 230. The back light reflection section 221 includes a back mirror 222, preferably with an ideal reflectivity, i.e. r₃=1. The front partial reflecting section 220 includes a pair of partially reflective surfaces 224 (reflectivity r₁₁) and 226 (reflectivity r₁₂) wherein both of the reflectivities r₁₁ and r₁₂ are less than 1. The partially reflective surfaces 224 and 226 are placed in parallel to each other and are spaced apart by a distance d. The gap 228 between the first and second mirrors 224 and 226 is filled with a material with a variable index of refraction, e.g. a thin layer of electro-optic materials, such as liquid crystal. Voltage V is applied between electrodes 238 and 239 by a voltage source 240 to vary the refractive index of the liquid crystal, and therefore vary the reflectivity of the variable partial reflector 211. The reflective surface 226 and the back mirror 222 are also placed in parallel to each other at a distance d₀ forming the interference cavity 230. The front partial reflecting section 220 includes an input port 250 and an output port 252 to allow light to be launched into and out of the interference cavity 230. The width d₀ of the interference cavity 230 is chosen to have the free spectra range (FSR) aligned with the International telecommunication Union (ITU) grid of channel spacing.

The FSR is defined by:

FSR=c/2n_{g}d₀ (1)

wherein c is the velocity of light, and n_{g} is the group refractive index of the interference cavity, which in the case of the an air-spaced etalon is 1.

Since the refractive index of the liquid crystal in the gap 228 is varied in response to the applied voltage V, the time (group) delay among frequency components of the input light can be adjustable and variable within a range of a few milliseconds or less, resulting in the light reflectivity of the variable partial reflector 211 being variable.

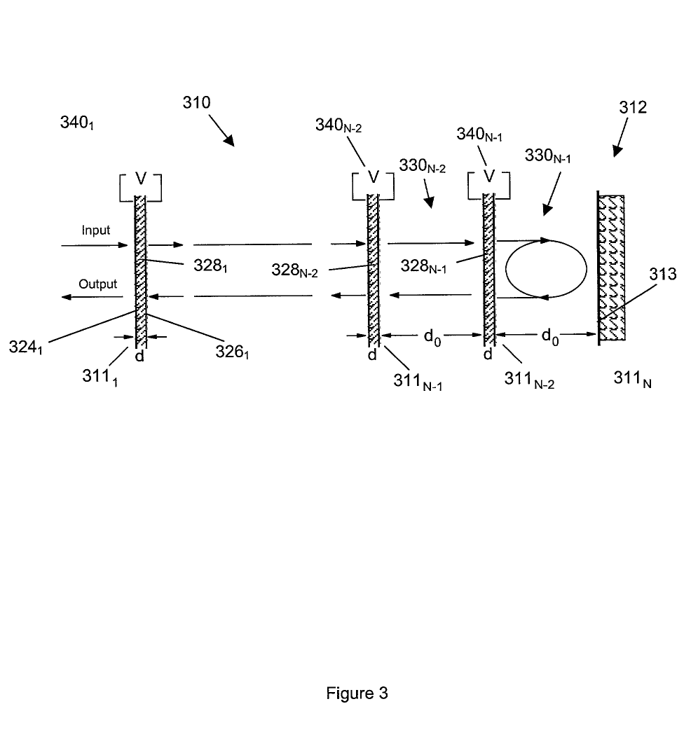

FIG. 3 illustrates an apparatus according to another embodiment of the present invention including a multi-cavity etalon having multiple tunable partial reflectors defining multiple interference cavities. In FIG. 3, the etalon includes a front partial reflecting section 310 and a back light reflection section 312. The etalon has a plurality (N−1) of variable partial reflectors 311₁ to 311_{N-1} and a back mirror 313. Each variable partial reflector 311 includes a pair of partially reflective surfaces 324 and 326 defining a gap 328 therebetween. Each gap 328 is filled with a material that has an index of refraction that can be varied and controlled by an outside source. In a preferred embodiment an electro-optic material, such as liquid crystal, is used. An interference cavity 330 is formed between each pair variable partial reflectors 311, and between the last variable partial reflector 311_{N-1} and the back mirror 313. Accordingly, the number of the interference cavities 330 is N−1. In the front partial reflecting section 310, voltage sources 340₁ to 340_{N-}1 independently apply voltages V to the material, e.g. liquid crystal, in each of the gaps 328 to vary the index of refraction. Accordingly, the reflectivity and the transferability of each partial reflector 311 are variably adjusted in response to the applied voltage V.

In dealing with a stack of N mirrors in a Fabry-Perot interferometer (like the etalon shown in FIG. 3), to some extent, the matrix method is more informative in analysis and design than the Z-transform approach. If E₁⁺ and E_{N}⁺ are the amplitude of incident electric-field vector of the first mirror and the Nth mirror, and E₁⁻ and E_{N}⁻ are the amplitude of reflected electric-field vector of the first mirror and the Nth mirror. A general result can be expressed in the following matrix formulation:

$$( \begin{matrix}{E}_{1}^{+} \\ {E}_{1}^{-}\end{matrix} ) = {\prod }_{i = 1}^{N - 1} \frac{1}{{t}_{i}} ( \begin{matrix}exp ( - i {ϕ}_{i} ) & - {r}_{i} exp ( i {ϕ}_{i} ) \\ - {r}_{i} exp ( - i {ϕ}_{i} ) & exp ( i {ϕ}_{i} )\end{matrix} ) \times ( \begin{matrix}{E}_{N}^{+} \\ {E}_{N}^{-}\end{matrix} ) = \frac{1}{{t}_{1} {t}_{2} … {t}_{N - 1}} ( \begin{matrix}{M}_{11} & {M}_{12} \\ {M}_{21} & {M}_{22}\end{matrix} ) \times ( \begin{matrix}{E}_{N}^{+} \\ {E}_{N}^{-}\end{matrix} ) \qquad ( 2 )$$

where M₁₁, M₁₂, M₂₁, and M₂₂ are the coefficients of the resultant matrix, and

$${ϕ}_{i} = \frac{2 π}{λ} {n}_{gi} {d}_{i} , and {n}_{gi} ,$$

is the group refraction index of the material between mirror i and mirror i+1, dᵢ is the distance between mirror i and mirror i+1, is the wavelength of the radiation in air. Moreover, rᵢ and tᵢ is the electric field reflection and transmission coefficients, respectively, wherein the mirror's reflectivity R equals r². The amplitudes of transmissions and reflections of the N mirror etalon are defined by:

t=E_{N+1}⁺/E₁⁺=t₁t₂ . . . t_{N}/(M₁₁−r_{N}M₁₂) (3)

r=E₁⁻/E₁⁺=(M₂₁−r_{N}M₂₂)/(M₁₁−r_{N}M₁₂) (4)

With Equations (3) and (4), the phase responses of transmission and reflection can be written as:

$${Φ}^{t} = {Tan}^{- 1} ( \frac{I m ( t )}{R e ( t )} ) and {Φ}^{r} = {Tan}^{- 1} ( \frac{I m ( r )}{R e ( r )} ) \qquad ( 5 )$$

Once an analytical phase response expression is given, the group delay (GD) can be easily calculated by:

$$G D = \frac{{λ}^{2}}{2 π c} \frac{ⅆ Φ}{ⅆ λ} \qquad ( 6 )$$

and the chromatic dispersion (CD) can be calculated by:

$$C D = \frac{ⅆ G D}{ⅆ λ} \qquad ( 7 )$$

Equations (6) and (7) provide the designing tools to calculate group delay GD and chromatic dispersion CD.

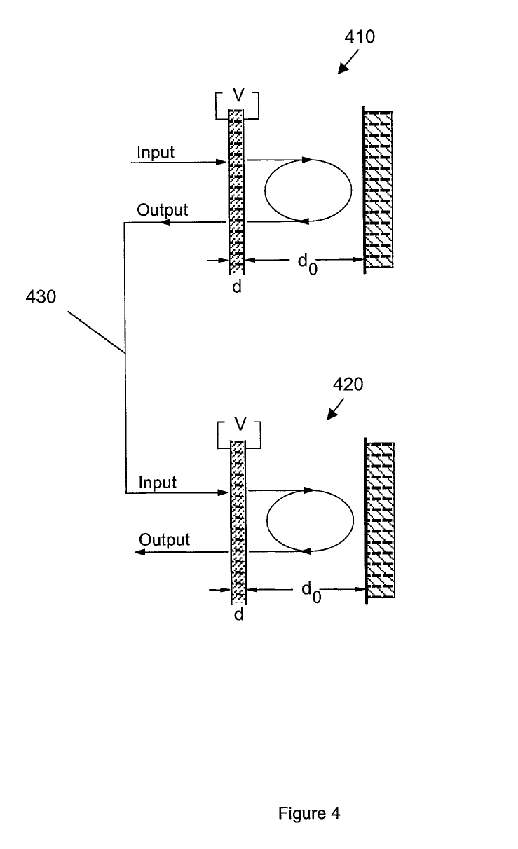

FIG. 4 illustrates an apparatus according to another embodiment of the present invention. The apparatus includes a cascaded pair of etalons 410 and 420, each of which has the same structure as that of the air-spaced etalon 200 shown in FIG. 2. The output light from the first etalon 410 is fed to the second etalon 420 through a fiber 430.

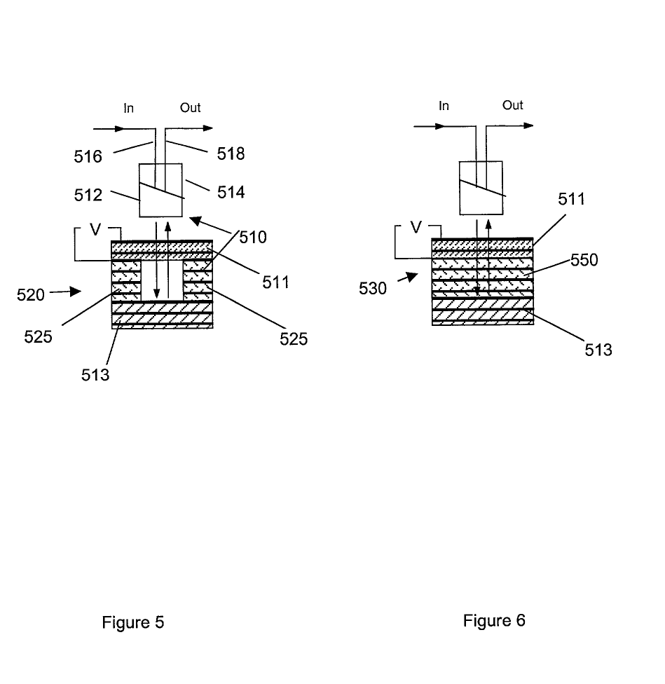

FIG. 5 illustrates an apparatus according to another embodiment of the present invention, in which an input/output structure 510 includes a lens 512 and a double bore ferrule 514, which encases the ends of an input fiber 516 and an output fiber 518. The structure of the air-spaced etalon 520 is basically the same as the etalon 200 shown in FIG. 2. The front and back mirrors 511 and 513, respectively, are secured to each other with spacers 525 of crystal or another low temperature-expansion material. Before entering into the etalon 520, the input light launched from the input fiber 516 is collimated by the lens 512. The output light from the etalon 520 is focused by the lens 512 and transferred through the output fiber 518.

FIG. 6 illustrates an apparatus according to another embodiment of the present invention including a solid etalon 530. The structure of the etalon 530 is essentially the same as the etalon 200 shown in FIG. 2; however, the front partially reflecting section 511 and the back mirror 513 of the etalon 530 are attached to each other by low temperature-expansion material 550 (non-temperature sensitive and light transferable material) to form a solid etalon. In the solid etalon 530, a refraction index n_{g} of the interference cavity is not 1. Function and operation of the solid etalon 530 are essentially the same as those of the air-spaced etalon 520.

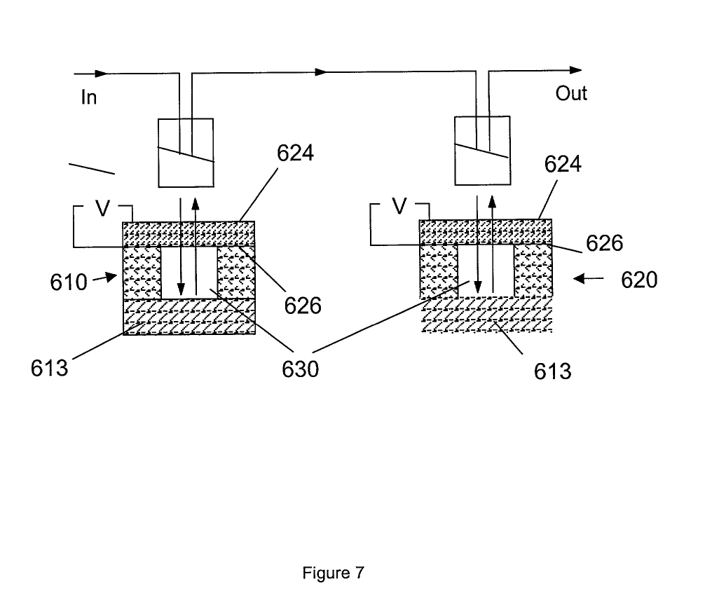

FIG. 7 illustrates an apparatus according to another embodiment of the present invention in which a pair of etalons 610 and 620 are connected in series, each of the etalons being an air-spaced etalon as in FIG. 5. In this embodiment, the pair of etalons 610 and 620 are used for dispersion compensation by aligning a positive dispersion slope of etalon 610 with a negative dispersion slope of etalon 620, which is achieved by properly choosing the various parameters, such as the reflectivities r₁ and r₂ of the partially reflective surfaces 624 and 626, respectively, the width d of the gap between the partially reflective surfaces 624 and 626, the reflectivity r₃ of the back mirror 613, the width d₀ of the cavity 630, and the voltage V.

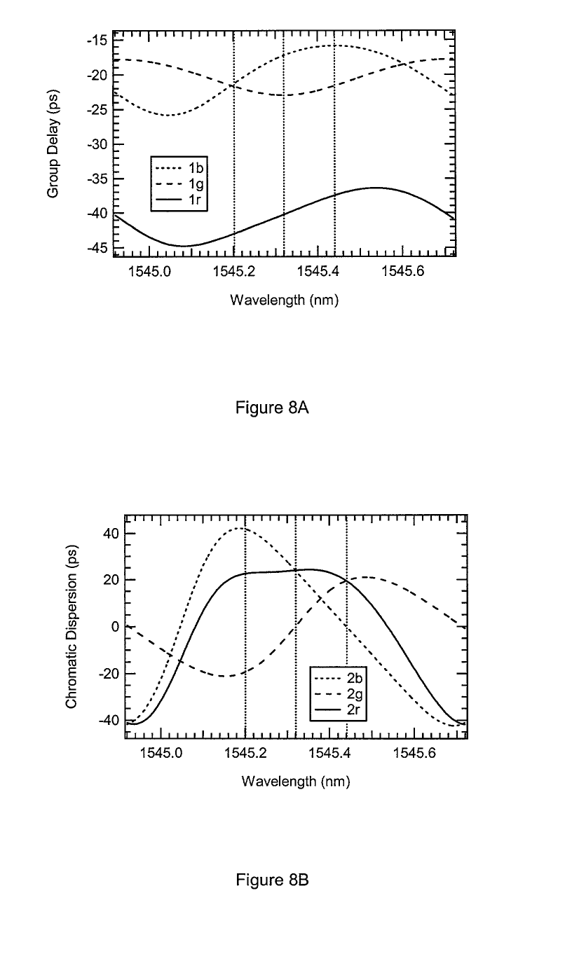

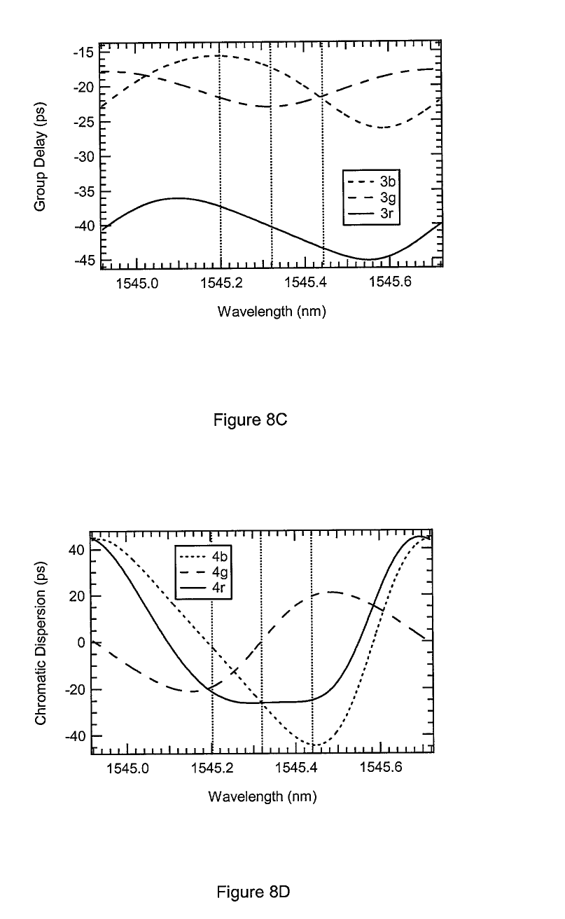

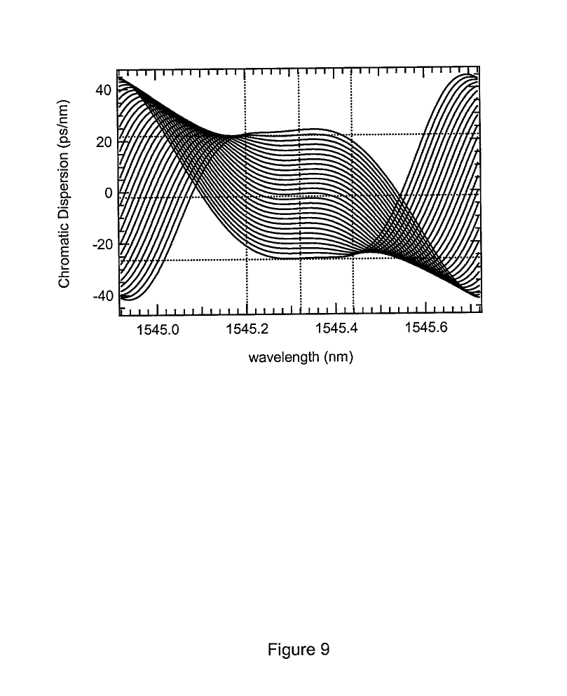

FIGS. 8A-8D show wavelength-group delay and wavelength-group dispersion characteristics in the apparatus including the two etalons shown in FIG. 7, in which etalon 610 includes partially reflective surfaces of r₁=0.12 and r₂=0.01 spaced apart by d=10 μm and in which etalon 620 includes partially reflective surfaces of r₁=0.065 and r₂=0.005 spaced apart by d=10 μm. In FIG. 8A, curves 1g and 1b represent the group delays of the etalons 610 and 620, respectively, while curve 1r represents the resulting combination of both group delays. In FIG. 8B, curves 2g and 2b represent the dispersions of the etalons 610 and 620, respectively, while curve 2r represents the resulting combination of both dispersions. It is obvious that the paired etalons achieve a flat top bandwidth.

While the paired etalons can be tuned to give the maximum positive dispersion, they may also be tuned to give the maximum negative dispersion. Curves 3g and 3b in FIG. 8C represent negative group delays of the etalons 610 and 620, respectively, while curves 4g and 4b in FIG. 8D represent the corresponding negative dispersions of the etalons 610 and 620, respectively. Curves 3r and 4r in FIGS. 5C and 5D, respectively, represent the resulting group delay and dispersion from the combination of both etalons. In this case the tuned pair of etalons 610 and 620 achieve a maximum negative dispersion with a flat bandwidth.

In FIGS. 8A-8D, the center gridlines indicate ITU position Ch40, (FSR=100 GHz). As shown in FIGS. 8B and 8D, a reasonably good flat top bandwidth ±15 GHz (0.24 nm) is obtained.

One of the easiest ways of tuning the device is to keep one etalon fixed and to tune the other, i.e. varying the voltage V resulting in a change of refractive index of the electro-optic materials of the gap. Such is the case as illustrated in FIG. 9, wherein the etalon 610 (curves 2g and 4g) is fixed and the etalon 620 (curves 2b and 4b) is tuned by lowering the specific group refraction index from n_{g}=1.64 to 1.614 in increments of 0.002. Accordingly, a tunable ±20 ps/nm dispersion compensator is thereby obtained.

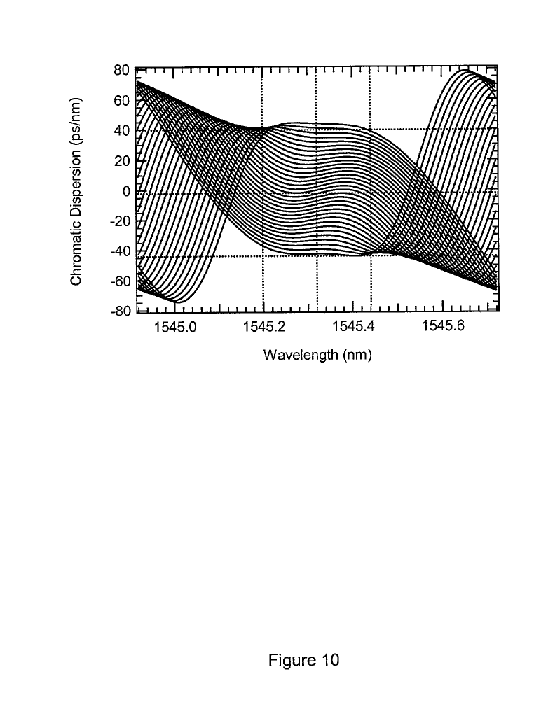

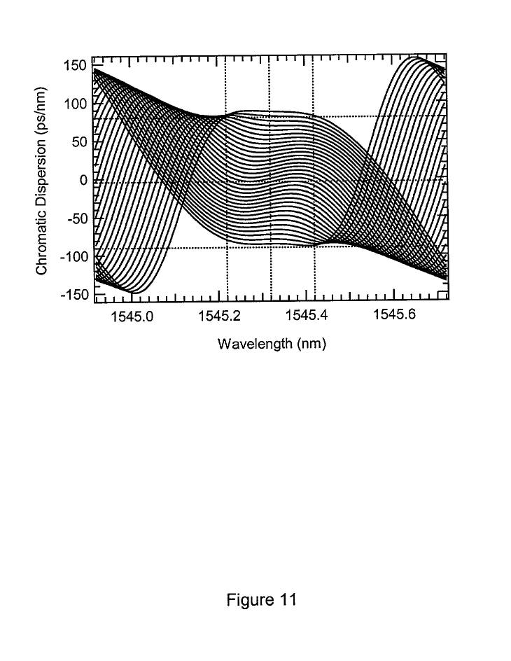

For electro-optic materials, generally,

$${n}_{l}^{ij} = {n}_{ol}^{ij} - \frac{1}{2} {n}_{l}^{3} {\vec{r}}_{ij} V ,$$

where \vec{rᵢⱼ} is the electro-optic coefficient, the indices i and j relate to the directions of the principal-axes of the crystals and the electrical field, which can effect the polarization status of the light. By choosing properly cut crystals, one may be able to avoid dealing with the polarization diversity. To fully take advantage of the ability to individually tune the etalons, an algorithm for varying the voltage V of both etalons can be worked out to optimize the tuning range, bandwidth and dispersion ripple. FIG. 10 gives an example of the dispersion response when tuning both of the etalons to achieve a larger range, i.e. ±40 ps/nm.

There are quite a few advantages in using the aforementioned tunable cavity, i.e. a liquid crystal cell including a pair of mirrors having reflectivity r₁, and r₂ spaced apart by a distance d, e.g. d˜10 μm.

If the reflectivity r₂ is very small, it will essentially tune only the phase of dispersion curve;

By giving some value of the reflectivity r₂, both phase and amplitude can be tuned;

The tolerances of the cavity depth and the reflectivity can be significantly relaxed through variation of the reflectivity of the tunable layer; and

Each etalon can be tuned individually to optimize the amplitudes, passband width and dispersion ripples. As an example, with the same pair of etalons, by tuning both etalons, it is possible to actually double the tunable range from ±20 ps/nm in FIG. 9 to ±40 ps/nm in FIG. 10, yet still maintaining the same bandwidth.

The bandwidths, amplitudes, and tuning range can be further improved, by properly manipulating values of r₁, r₂, d, n_{g1}, Δn_{g1}, but often this would result in some kind of trade off, e.g. a wider flat top bandwidth would result in smaller dispersion amplitude. The best method of constructing such an apparatus is using the input/output structure 510, as shown in FIGS. 5-7; however, the etalon can have either an air filled cavity (as shown in FIG. 5) or simply a solid cavity (as shown in FIG. 6) if used in a temperature controlled environment. The pair of etalons as shown in FIG. 7 can be cascaded as many times as needed to obtain a larger dispersion. By cascading two pairs, the dispersion can be approximately ±80 ps/nm, as shown in FIG. 11.

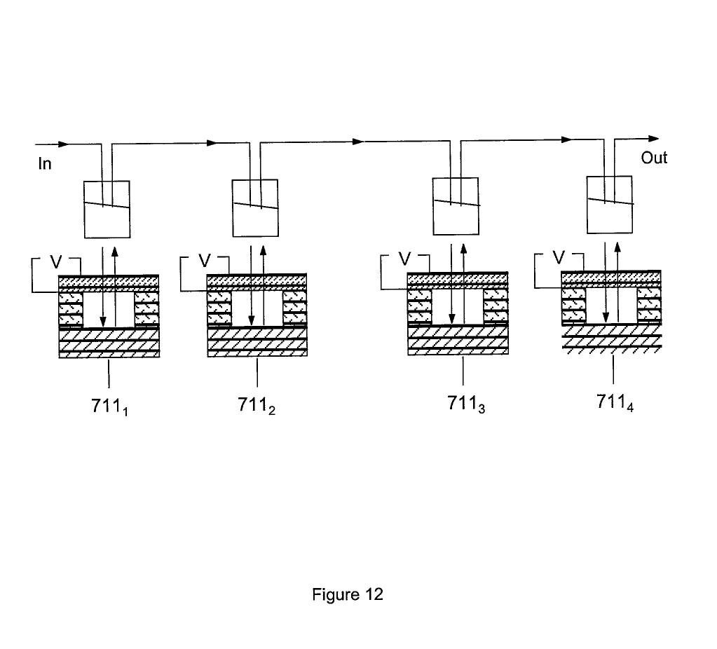

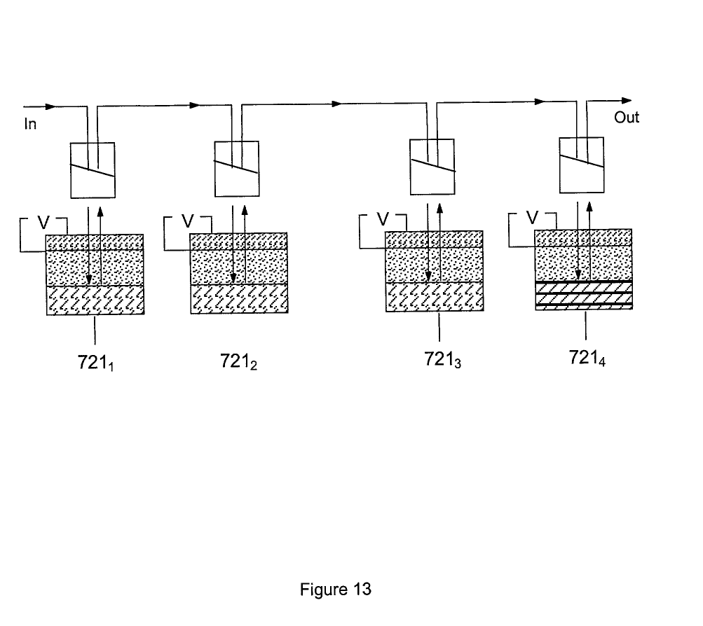

FIG. 12 shows an apparatus according to another embodiment of the present invention, which includes four etalons connected in series. Each of the etalons has the same structure as that of the air-spaced etalon shown in FIG. 5. The four etalons comprise two pairs of etalons with their dispersion slopes matched, as in FIG. 7. Light is fed to and received from the first etalon 711₁ via a first input/output structure 710₁. Light output from the first etalon 711₁ is fed to the adjacent etalon 711₂ via a second input/output structure 710₂, and so on until output light is provided by the last etalon 711₄. A plurality of solid etalons 721₁-721₄ (as shown in FIG. 6) can be also connected in series as shown in FIG. 13. Also, it is possible to arrange a combination of series-connected air-spaced etalons and solid etalons.

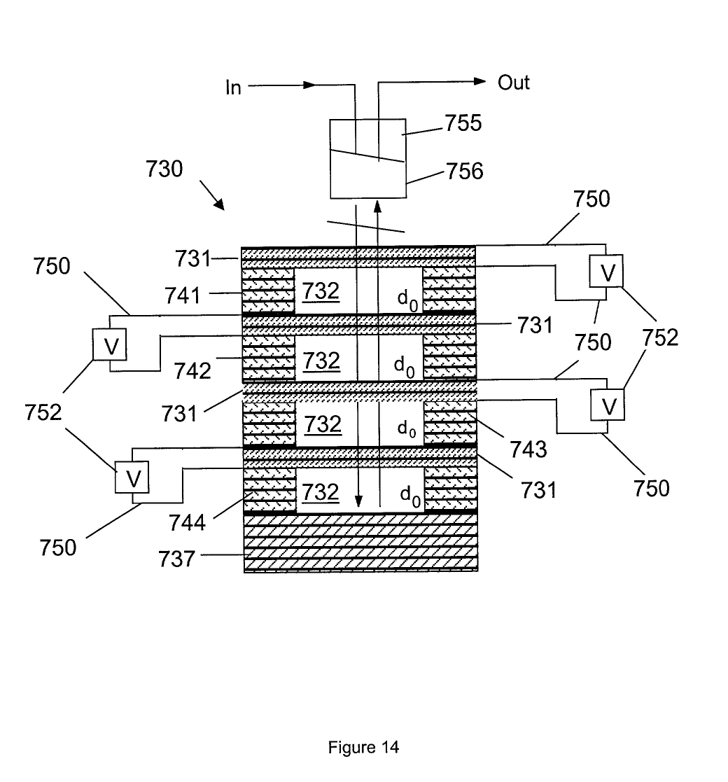

FIG. 14 illustrates an apparatus according to a specific embodiment of the present invention according to FIG. 3 including a multi-cavity etalon 730 having four tunable front mirrors 731 and four resonator cavities 732. The four variable partial reflectors 731 are aligned with a back light reflection section or a back mirror 737. These sections are air-spaced from each other by respective crystal spacers 741, 742, 743 and 744, which define resonant cavity widths of d₀. Each of the four variable partial reflectors 731 has the same structure as that of the variable partial reflector 211 as shown in FIG. 2, i.e. including two parallel reflective surfaces and a liquid crystal layer therebetween.

The distance (depth) d₀ of each of the interference cavities is chosen to have the FSR aligned with the ITU grid of channel spacing, the FSR being defined by Equation (1).

Voltage V is applied to two electrodes 750 of each of the variable partial reflectors 731 by a respective voltage source 752. As above, in response to the applied voltage V, the electric field induced in the liquid crystal varies the refractive index thereof, thereby changing the light reflectivity of that variable partial reflector 731. However, in a case the same voltage V can be applied to all of the variable partial reflectors 731 by a single voltage source, whereby their light reflectivities are commonly adjustable or, alternatively, each variable partial reflector 731can be individually adjusted using four separate voltage sources.

The etalon 730 includes a single double bore ferrule 755 with a lens 756 (e.g. a GRIN lens) which are the same as the etalon shown in FIG. 5.

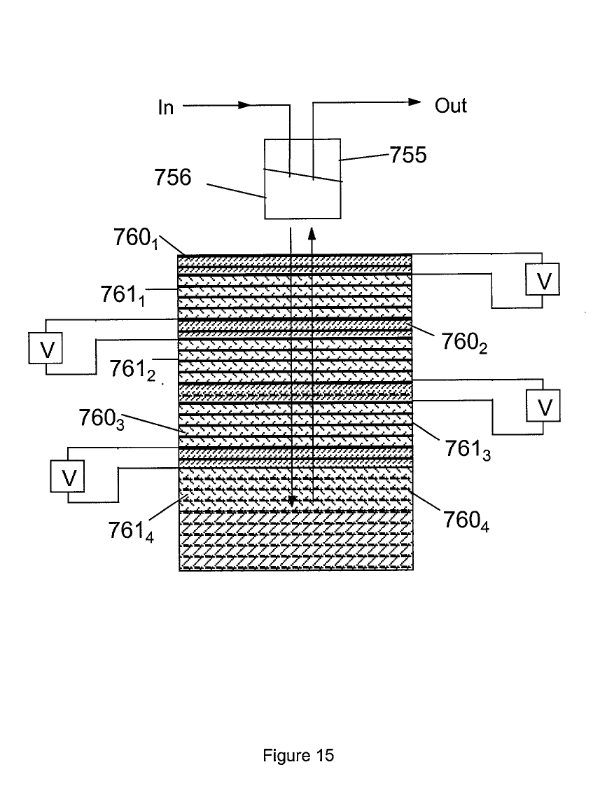

FIG. 15 shows an apparatus according to another embodiment of the present invention including a solid multi-cavity etalon having multiple variable partial reflectors 760 and multiple interference cavities 761. The structure of the etalon is basically the same as that of the etalon 730 in FIG. 14, with the exception that each of the interference cavities 761₁-761₄ is a solid cavity comprising a low temperature expansion material.

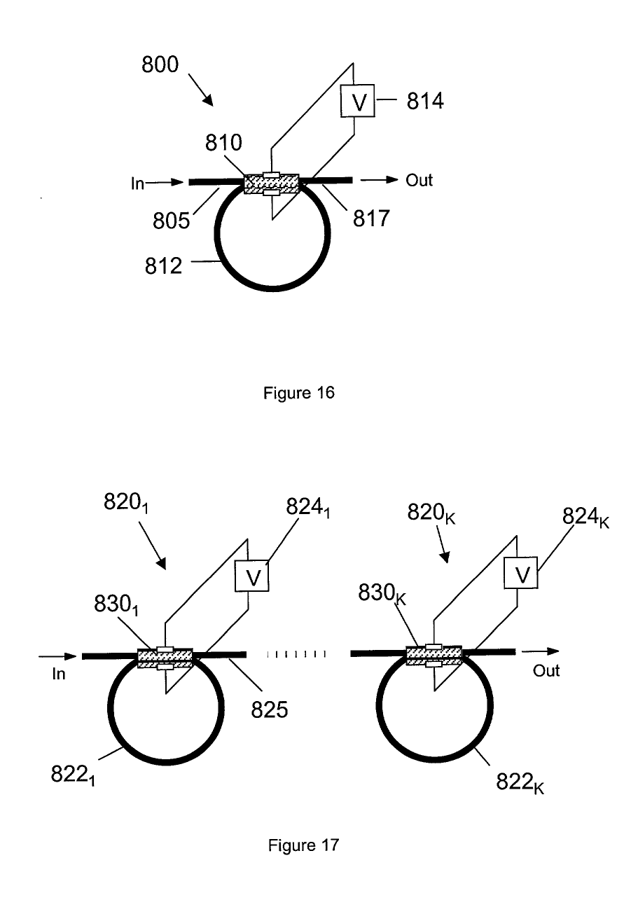

FIG. 16 illustrates an apparatus according to another embodiment of the present invention, which includes a ring resonator device 800. The device 800 includes an input waveguide 805, a variable coupler 810 and a ring resonator 812, and an output waveguide 817. The coupler 810, like the aforementioned gaps in the variable partial reflectors, includes a material with a variable index of refraction controlled by a voltage source 814. Incoming light is fed from the input waveguide 815 to the coupler 810. The coupling ratio of the coupler 810, i.e. the amount of light transferred into the ring resonator 812, is variably adjusted by changing the refractive index of the material therein. Thereafter, light from the ring resonator 812 interferes with the remaining input light and is output via waveguide 817.

FIG. 17 illustrates an apparatus according to another embodiment of the present invention, which includes a plurality of cascaded ring-resonator devices 820₁ to 820_{K}, each one similar to the device of FIG. 16. The devices 820₁ to 820_{K} are connected by a single waveguide 825, which transfers the light therebetween. Each device 820_{1 to K} includes a ring resonator 822_{1 to K} and a respective coupler 830_{1 to K}. As with the aforementioned GT etalons, pairs of ring resonator devices 820 are adapted so that they have opposite dispersion curves to provide tunable dispersion compensation. The couplers 830 can be commonly adjusted or individually tuned by voltage sources 824₁ to 824_{K}.

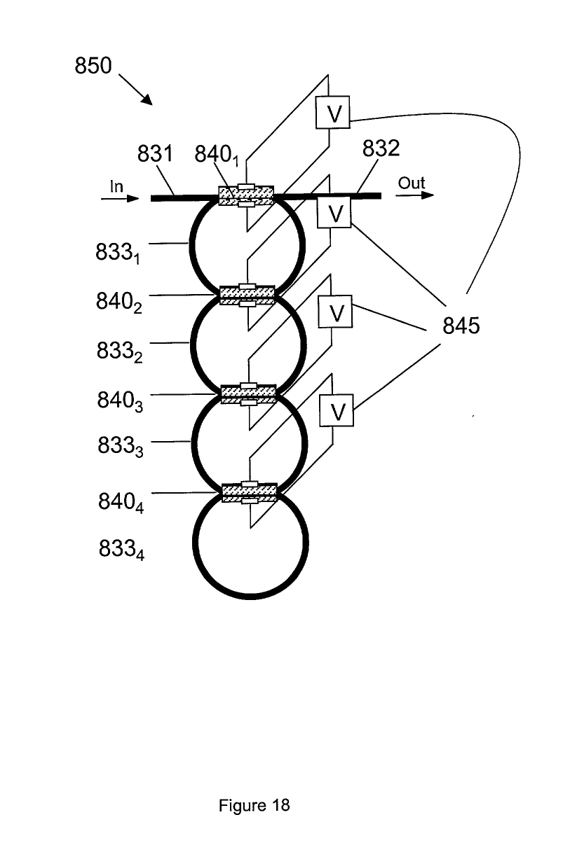

FIG. 18 illustrates a multi-ring ring resonator device 850 for use in a dispersion compensator. The device 850 includes a plurality (i.e. four) of ring resonators 833₁ to 833₄ in the form of a lattice, a light input waveguide 831, a light output waveguide 832, and a plurality of variable couplers 840₁ to 840₄.

In the apparatus, the input light is fed to the first variable coupler 840₁ through the input waveguide 831. Each of the variable couplers 840₁ to 840₄ partially reflects and transfers light fed thereto. Light transferred by one coupler 840ᵢ is transferred to the next coupler 840ᵢ₊₁ through the ring resonator 833ᵢ. Each coupler 840ᵢ₊₁ transfers a portion of the light to the next ring resonator 833ᵢ₊₁, while maintaining the remaining light in the same ring resonator 833ᵢ. Accordingly, only a portion of the original input light gets propagated through the four variable couplers 840₁ to 840₄ and through the four ring portions 833₁ to 833₄. The light reflectivities of the four couplers 840₁ to 840₄ are commonly or individually varied by voltage sources 845.

Although particular embodiments of the present invention have been described in detail, there are numerous variations. It should be appreciated that numerous variations, modifications, and adaptations may be made without departing from the scope of the present invention as defined in the claims.

What is claimed is:

1. A tunable etalon apparatus for receiving input light having input frequency channels therein and for providing output light therefrom, the output light having frequency channels corresponding to the input frequency channels with a relative time delay therebetween, the tunable etalon apparatus comprising:
a first variable partial reflector for reflecting and transmitting portions of the input light, the first variable partial reflector comprising:
a pair of partially reflective surfaces defining a gap therebetween, the gap comprising a material with a variable index of refraction; and
control means for adjusting the index of refraction of the material in the gap, thereby controlling the time delay of the input frequency channels;
and
a back reflector for reflecting the transmitted light back to the partial reflector, the back reflector and the first variable partial reflector forming a cavity therebetween;
wherein light reflected by the back reflector is partially reflected by and transmitted through the partial reflector, thereby causing interference in the output light.

2. The apparatus of claim 1, wherein the gap between the pair of partially reflective surfaces being filled with electro-optic material.

3. The apparatus of claim 2, wherein the electro-optic material comprises liquid crystal.

4. The apparatus of claim 2, wherein the control means comprises means for applying voltage to the electro-optic material for varying the index of refraction of the electro-optic material.

5. The apparatus according to claim 1, further comprising one or more additional variable partial reflectors spaced apart from the first variable partial reflector forming one or more additional cavities, each variable partial reflector comprising:
a pair of partially reflective surfaces defining a gap therebetween, the gap comprising a material with a variable index of refraction; and
control means for adjusting the index of refraction of the material in the gap, thereby controlling the time delay of the input frequency channels.

6. The apparatus of claim 5, wherein the each of the cavities is an air-spaced cavity or a solid cavity.

7. The apparatus of claim 1, further comprising:
input means for launching the input light into the apparatus;
output means for transferring the output light from the apparatus;
collimating means for collimating the input light launched by the input means;
focusing means for focusing the output light onto the output means.

8. The apparatus of claim 7, wherein the input means and the output means comprise a dual fiber ferrule encasing an end of an input fiber and an output fiber; and wherein the collimating means and the focusing means comprise a single graded index (GRIN) lens optically coupled to the dual fiber ferrule.

9. A dispersion compensator comprising cascaded first and second tunable etalons according to claim 1.

10. The dispersion compensator according to claim 9, wherein the first and second tunable etalons have substantially equal and opposite dispersion curves forming an overall dispersion curve that has a flat top bandwidth for each frequency channel.

11. The dispersion compensator according to claim 10, further comprising third and fourth tunable etalons according to claim 1, cascaded with each other and with the first and second tunable etalons.

12. The dispersion compensator according to claim 11, wherein the third and fourth tunable etalons have substantially equal and opposite dispersion curves forming an overall dispersion curve that has a flat top bandwidth for each frequency channel.

13. A tunable resonator apparatus for receiving input light having input frequency channels therein and for providing output light therefrom, the output light having frequency channels corresponding to the input frequency channels with a relative time delay therebetween, the tunable resonator apparatus comprising:
an input waveguide for launching the input light;
an output waveguide for transmitting the output light;
a ring resonator having an input and an output; and
a first variable coupler for coupling and distributing light from the input waveguide and the ring resonator output to the output waveguide and the ring resonator input, the first variable coupler including:
a material with a variable index of refraction; and
control means for adjusting the index of refraction of the material, thereby controlling the time delay of the input frequency channels;
wherein input light coupled into the ring resonator by the first variable coupler is transmitted back to the first variable coupler, thereby causing interference in the output light.

14. The apparatus of claim 13, wherein the material is an electro-optic material.

15. The apparatus of claim 14, wherein the electro-optic material comprises liquid crystal.

16. The apparatus of claim 14, wherein the control means comprises means for applying voltage to the electro-optic material for varying the index of refraction of the electro-optic material.

17. A dispersion compensator comprising cascaded first and second tunable resonators according to claim 13.

18. The dispersion compensator according to claim 17, wherein the first and second tunable resonators have substantially equal and opposite dispersion curves forming an overall dispersion curve that has a flat top bandwidth for each frequency channel.

19. The dispersion compensator according to claim 18, further comprising third and fourth tunable etalons according to claim 13.

20. The dispersion compensator according to claim 19, wherein the third and fourth tunable resonators have substantially equal and opposite dispersion curves forming an overall dispersion curve that has a flat top bandwidth for each frequency channel.
